(19) United States
(12) Patent Application Publication
(10) Pub. No.: US 2008/0205958 A1
(43) Pub. Date: Aug. 28, 2008

(54) Tape printer, tape printing progam and tape cassette

(75) Inventors: Satoru Moriyama, Iwakura-shi (JP); Nako Yoshimura, Nagoya-shi (JP); Yoshihiko Sugimura, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/069,217

(22) Filed: Feb. 8, 2008

(30) Foreign Application Priority Data
Feb. 9, 2007 (JP) 2007-031001
Nov. 2, 2007 (JP) 2007-285720

(51) Int. Cl. B41J 5/00

(52) U.S. Cl. 400/62

(57) ABSTRACT

A tape printer for printing a tape stored in a detachable tape cassette includes a detection device that detects a type of a loaded tape cassette, a receiving device that receives data from an external device, a permission determination device that determines whether or not the type of the cassette detected by the detection device is the one permitting a predetermined action except ordinary printing instructed in data received by the receiving device, and an operation control device that enables the predetermined action if it is determined to be permitted by the permission determination device.

### CROSS-REFERENCE TO RELATED APPLICATION

This Application claims priority from Japanese Patent Application No. 2007-31001, filed Feb. 9, 2007, and No. 2007-285720, filed Nov. 2, 2007, the disclosure of which is hereby incorporated by reference in its entirety.

### BACKGROUND

The present disclosure relates to a tape printer for printing a tape stored in a tape cassette, a tape printing program and a tape cassette for use in the tape printer.

Conventionally, a tape printer for creating a tape-shaped label has been known. This type of tape printer is so constructed that a tape cassette can be attached or detached. The tape cassette stores a tape as a print medium and a print ribbon and the tape is printed by a thermal head. Plural types of tapes that are different in width or structure can be used, so plural types of the tape cassettes storing each tape are prepared. There has been proposed a printer for carrying out integrated control and batch processing about each of the tape types to printing object data corresponding to diversified types of the tapes (see Japanese Patent Application Laid-Open No. 2004-130682).

Under circumstances of accelerated building of network society in recent years, there is a need of connecting a plurality of tape printers to a host computer and distributing necessary print data from the host computer to the tape printers. There is another need of distributing from the host computer to the tape printers a template which is a predetermined layout, font for printing, and updated data of programs as well as print data.

However, if the print data is sent to all the tape printers connected to the host computer simultaneously, printing is carried out at all the tape printers. This does not satisfy printing dependent on a need at respective tape printers. Although the host computer can transmit a print data to a selected tape printer, it is complicated and takes labor and time, which is a problem to be solved.

### SUMMARY

Various exemplary embodiments of the broad principles herein provide a tape printer, a tape printing program and a tape cassette that are capable of executing a predetermined action by selecting data received from the host computer.

Exemplary embodiments provide a tape printer for printing a tape stored in a detachable tape cassette that includes a detection device that detects a type of a loaded tape cassette, a receiving device that receives data from an external device, a permission determination device that determines whether or not the type of the cassette detected by the detection device is the one permitting a predetermined action except ordinary printing instructed in data received by the receiving device, and an operation control device that enables the predetermined action if it is determined to be permitted by the permission determination device.

Exemplary embodiments also provide a tape print program recorded on a computer-readable recording medium, the program includes instructions that cause a controller of a tape printer for printing a tape stored in a detachable tape cassette to perform: detection step of detecting a type of the loaded cassette; receiving step of receiving data from an external device, a permission determination step of determining whether or not the type of the cassette detected in the detection step is the one permitting a predetermined action except ordinary printing instructed in data received by the receiving device, and an operation control step of enabling the predetermined action, if it is determined to be permitted, in the permission determination step.

Exemplary embodiments also provide a tape cassette for use in a tape printer that includes an identification section that makes the tape printer detect whether or not a predetermined action except ordinary printing is permitted to the tape printer.

### BRIEF DESCRIPTION OF THE DRAWINGS

Exemplary embodiments of the disclosure will be described below in detail with reference to the accompanying drawings in which:

FIG. 1 is a plan view showing a condition in which the lid of a tape storage portion of the tape printer is removed;

FIG. 2 is a perspective view of a tape cassette;

FIG. 3 is a bottom view of the tape cassette;

FIG. 4 is a plan view of a lower case of the tape cassette when an upper case is removed;

FIG. 5 is an explanatory diagram showing the relationship between an identifying portion and a detection switch;

FIG. 6 is a block diagram showing a control configuration of the tape printer;

FIG. 7 is a schematic diagram of a configuration of a ROM;

FIG. 8 is a schematic diagram of a configuration of a RAM;

FIG. 9 is a flow chart of main processing of the tape printer;

FIG. 10 is a flow chart of system initialization processing to be executed in the main processing;

FIG. 11 is a flow chart of tape type detection processing to be executed in main processing;

FIG. 12 is a flow chart of key input processing to be executed in main processing;

FIG. 13 is a flow chart of template selection processing to be executed in key input processing;

FIG. 14 is a flow chart of font selection processing to be executed in key input processing;

FIG. 15 is a flow chart of text print processing to be executed in key input processing;

FIG. 16 is a flow chart of received data processing to be executed in main processing;

FIG. 17 is a flow chart of font addition processing to be executed in received data processing;

FIG. 18 is a flow chart of font addition processing to be executed in received data processing;

FIG. 19 is a flow chart of print processing to be executed in received data processing;

FIG. 20 is a flow chart of program updating processing to be executed in received data processing;

FIG. 21 is a schematic diagram showing an example of configuration of ordinary font data;

FIG. 22 is a schematic diagram showing an example of configuration of special font data;

FIG. 23 is a schematic diagram showing an example of configuration of ordinary template data;

FIG. 24 is a schematic diagram showing an example of configuration of special template data;

FIG. 25 is a schematic diagram showing an example of configuration of ordinary program data;

FIG. 26 is a schematic diagram showing an example of configuration of special program data; and

FIG. 27 is a schematic diagram showing an example of configuration of ordinary print data; and

FIG. 28 is a schematic diagram showing an example of configuration of special print data.

### DETAILED DESCRIPTION OF THE EXEMPLARY EMBODIMENTS

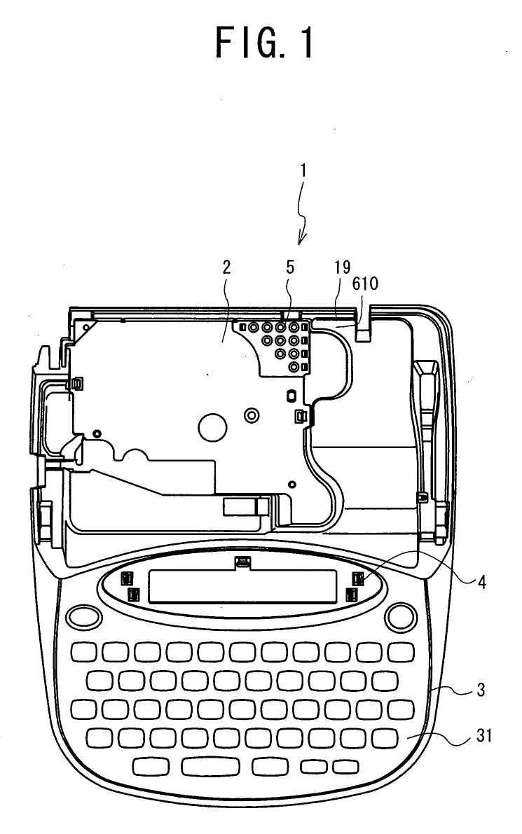

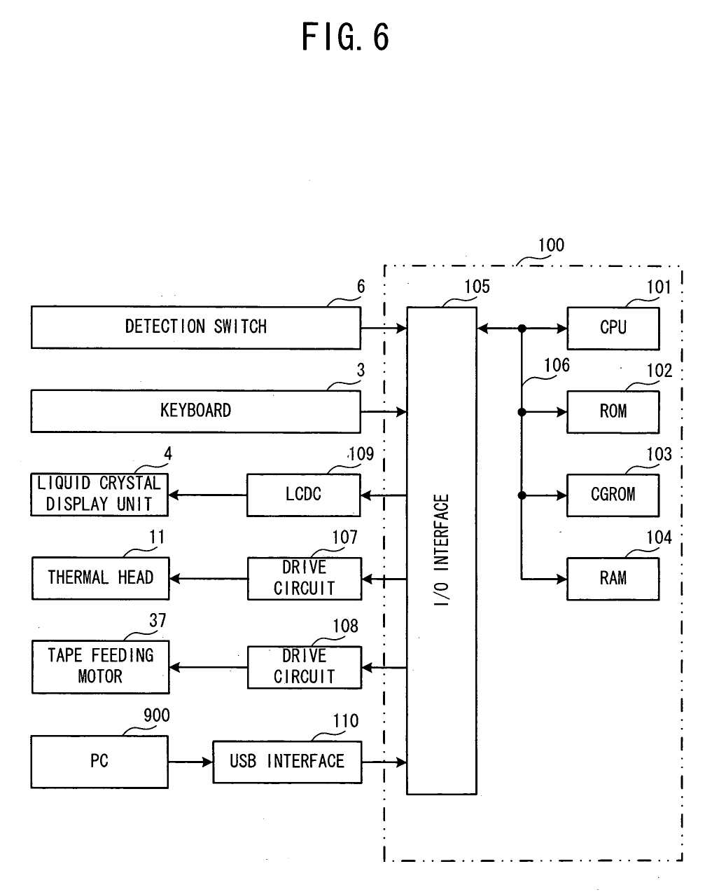

Hereinafter, a tape printer 1 according to an embodiment of the present invention will be described with reference to the accompanying drawings. According to this embodiment, a tape printer 1 can print characters and symbols inputted through a keyboard and can be connected to an external computer (PC 900. see FIG. 6), so that it can receive data from the PC 900 and execute printing based on the received data. As well as print data, font data for printing, a template data, data for updating a program of the tape printer 1 and the like may be transmitted from the PC 900. First, the physical structure of the tape printer 1 will be described with reference to FIG. 1.

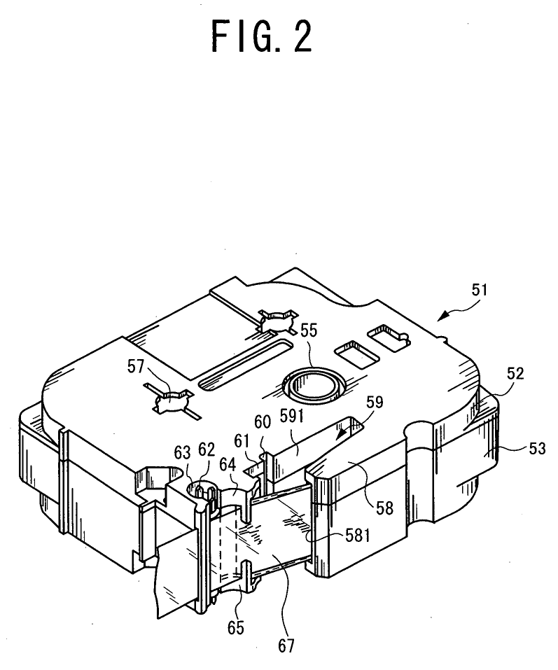

As shown in FIG. 1, a tape cassette storage portion 2 is provided at the rear portion of the tape printer 1. The tape cassette storage portion 2 is a concave portion to store a tape cassette 51 (see FIG. 2). A keyboard 3 for inputting characters and symbols is provided at the front portion of the tape printer 1. A plurality of keys 31 for inputting characters, symbols and functional commands are disposed on the keyboard 3. A liquid crystal display unit 4 is provided between the tape cassette storage portion 2 and the keyboard 3, in which characters, symbols and the like inputted through the keyboard 3 can be displayed.

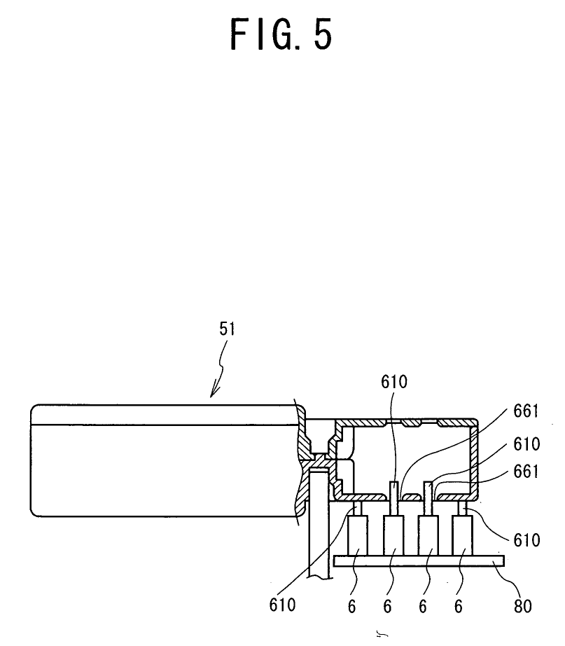

A cassette detecting portion 5 is provided in a corner (right top corner in FIG. 1) in the tape cassette storage portion 2 of the tape printer 1. The cassette detecting portion 5 contains plural holes 19, and plungers 610 of detection switches 6 (see FIG. 5) provided on a detection sensor substrate 80 (see FIG. 5) protrude from the respective holes 19. The detection switches 6 can detect a type of the tape cassette 51 stored in the tape cassette storage portion 2 in combination with identification holes 661 of the tape cassette 51.

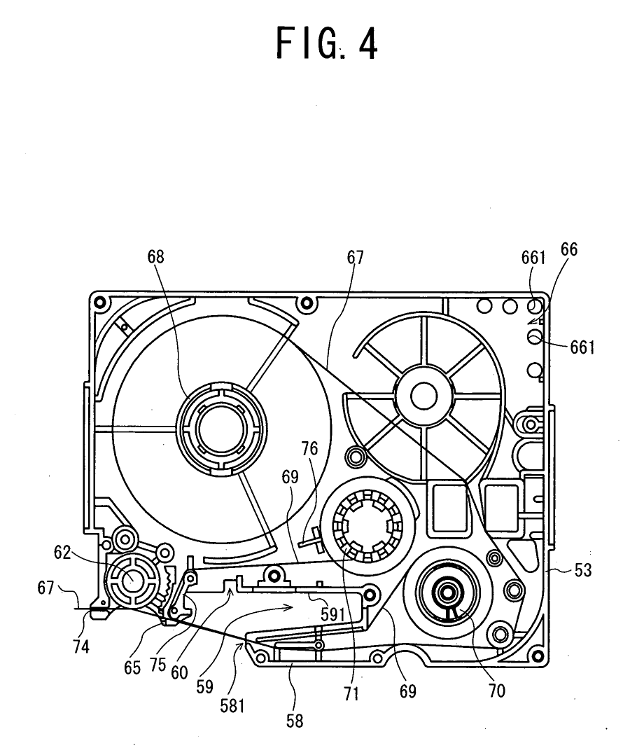

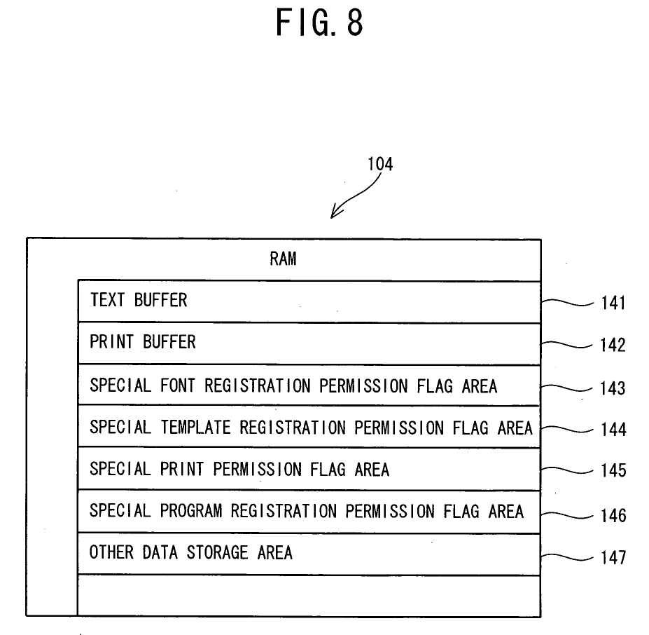

The structure of the tape cassette 51 to be loaded in the tape cassette storage portion 2 of the tape printer 1 will be described with reference to FIGS. 2-4. As shown in FIG. 2, the tape cassette 51 includes an upper case 52 and a lower case 53. The tape cassette 51 has a supporting hole 57 for rotatably supporting a tape spool 68 (see FIG. 4) wound outwardly with a separable paper of a print tape 67 that will be described later. The tape cassette 51 also has a ribbon take-up spool 71 (see FIG. 4) which pulls out a ink ribbon 69 (see FIG. 4) from a ribbon spool 70 (see FIG. 4) and takes it up when characters and the like are printed on the print tape 67 with a thermal head 11 (see FIG. 8).

Although FIG. 2 only represents the respective supporting holes 55 and 57 formed in the upper case 52, the lower case 53 also has supporting holes facing the respective supporting holes 55 and 57 in the upper case 52.

An arm portion 58 is provided at the front side (lower side in FIG. 2) of the tape cassette 51. The arm portion 58 guides the print tape 67 pulled out from the tape spool 68 (see FIG. 4) and the ink ribbon 69 pulled out from the ribbon spool 70 (see FIG. 4) and sends them out from an opening portion 581. A head mounting portion 59, into which the thermal head 11 of the tape printer 1 is to be mounted, is provided in the back portion of the arm portion 58.

In the head mounting portion 59, a first fitting portion 60 is formed in a wall portion 591 facing the arm portion 58 such that it is dented backward of the tape cassette 51. A second fitting portion 61 is formed in the left side wall of the head mounting portion 59 such that it is dented in a direction perpendicular to the first fitting portion 60 (the direction along the wall portion 591). The first fitting portion 60 and the second fitting portion 61 are fitted to two projecting portions formed on a head holder (not shown) for supporting the thermal head. With such a structure, the thermal head can be securely placed in the head mounting portion 59 without interference with the ink ribbon 69 and the print tape 67.

A supporting hole 63 is provided downstream of the head mounting portion 59 with respect to a feeding direction of the ink ribbon 69 and the print tape 67. The supporting hole 63 rotatably supports a tape feeding roller 62. The tape feeding roller 62 pulls out the print tape 67 from the tape spool 68 in cooperation with a pressure roller (not shown) facing the tape feeding roller 62. A pair of restricting members 64 and 65 (an upper member 64 and a lower member 65) are provided in the vicinity of the tape feeding roller 62. The restricting members 64 and 65 restrict the print tape 67 in the width direction when the print tape 67, on which characters are printed, is fed downstream of the thermal head.

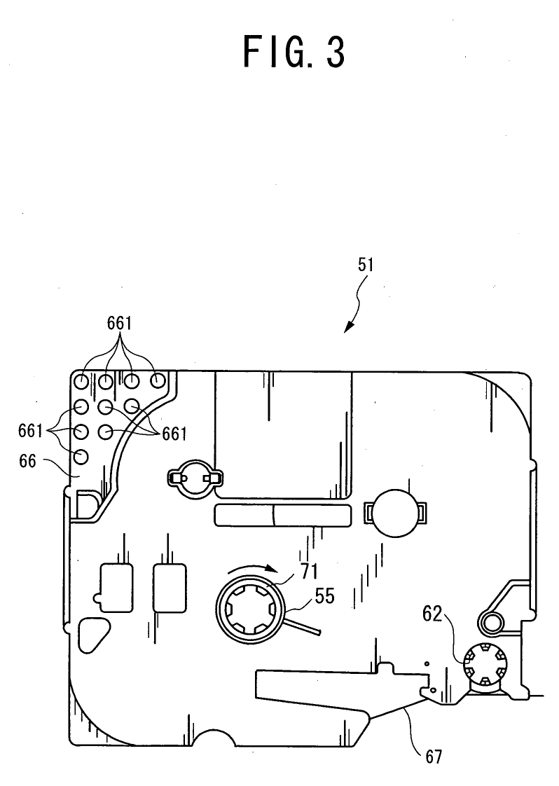

As shown in FIG. 3, an identification portion 66 is formed in the left rear edge of the tape cassette 51. The identification portion 66 includes a plurality of identification holes 661 having a predetermined pattern for detecting a type of the tape cassette 51. The type of the tape cassette 51 includes, for example, the width of each print tape 67, and whether special operation is permitted or prohibited (to be described later).

Next, the internal configuration of the tape cassette 51 will be described with reference to FIG. 4. As shown in FIG. 4, the tape spool 68 is disposed at the rear portion (upper portion in FIG. 4) in the lower case 53 such that it can be rotated around the supporting hole 57 described above. The print tape 67 is wound on the tape spool 68. The ribbon spool 70 on which the ink ribbon 69 is wound is, disposed rotatably at the front portion (lower portion in FIG. 4) of the lower case 53. The ribbon take-up spool 71 is disposed between the tape spool 68 and the ribbon spool 70 such that it can be rotated around the supporting hole 55 described above. The ribbon take-up spool 71 pulls out the ink ribbon 69 from the ribbon spool 70 and winds up the ink ribbon 69 that has been used for printing characters.

The print tape 67 is pulled out from the tape spool 68 by cooperation of the tape feeding roller 62 and the pressure roller (not shown) provided on the tape printer 1. The pulled-out print tape 67 comes out of the opening 581 in the arm portion 58, passes the front side (lower side in FIG. 4) of the head mounting portion 59, and then is discharged out of the tape cassette 51 through a tape discharge portion 74. The ink ribbon 69 is pulled out from the ribbon spool 70 by the ribbon take-up spool 71. The pulled out ink ribbon 69 comes out of the opening 581 in the arm portion 58, passes the front side (lower side in FIG. 4) of the head mounting portion 59, is guided by a guide portion 75 formed inside the restricting members 64 and 65, and then taken up around the ribbon take-up spool 71. A clutch spring 76 is provided on the bottom portion of the ribbon take-up spool 71 in order to prevent the ribbon take-up spool 71 from being rotated inversely to loosen the taken-up ink ribbon 69.

The plurality of the identification holes 661 are provided in the identification portion 66 on the right rear corner of the lower case 53.

Next, how the type of the tape cassette 51 is detected by the identification portion 66 and the detection switch 6 will be described with reference to FIG. 5. The identification holes 661 provided in the identification portion 66 have a different formation pattern depending on the type of the tape cassette 51. The plungers 610 of the detection switches 6 disposed in the cassette detection portion 5 of the tape printer 1 can be inserted into the respective identification holes 661. The detection switch 6 facing the corresponding identification hole 661 remains off. On the other hand, when the detection switch 6 faces a portion in which no identification hole 661 is formed, its plunger 610 is pressed down by the substrate of the identification portion 66 and the detection switch 6 is turned on. The type of the tape cassette 51 can be detected based on a combination of ON/OFF of the plural detection switches 6.

In this embodiment, 10 detection switches 6 are used. The tape width, type (laminate tape, receptor tape, fabric tape and the like) and printing energy are specified depending on a combination of No. 1 to No. 6 detection switches 6.

Whether the special operation instructed in data received from the PC 900 (see FIG. 6) is permitted or prohibited is specified by No. 7-10 of the detection switches 6. In this embodiment, registration of special fonts, registration of special templates, printing of special data, and updating of special programs are special operations. To execute these special operations, it needs to be permitted by a corresponding detection switch 6. That is, if No. 7 switch is OFF, registration of the special fonts is prohibited, and if it is ON, the registration of the special fonts is permitted. If No. 8 switch is OFF, registration of the special templates is prohibited, and if it is ON, the registration of the special templates is permitted. If No. 9 switch is OFF, printing of the special data is prohibited, and if it is ON, printing of the special data is permitted. If No. 10 switch is OFF, updating of the special program is prohibited, and if it is ON, the updating of the special program is permitted. Only when data for instructing the special operation is sent from the PC 900 to the tape printer 1 provided with the tape cassette 51 in which these special operation switches are ON, the corresponding special operation is carried out at the tape printer 1. Even if the same data is sent to another tape printer 1 without such tape cassette 51, the data is ignored and aborted because the corresponding special operation is not permitted.

The identification holes 661 are not necessarily hole shape but may be a concave portions formed on the outer surface of the identification portion 66 and dented toward the center in the width direction of the tape cassette 51. Namely, any dented shape which turns off the detection switch 6 when the plunger 610 of the facing detection switch 6 is inserted therein may be adopted instead of the hole.

Next, the electric configuration of the tape printer 1 will be described with reference to FIGS. 6-8. The control system of the tape printer 1 is built up around the control circuit unit 100 formed on the control board as its core. The control circuit unit 100 includes a CPU 101 for controlling respective devices, and an I/O interface 105, a CGROM 103, a ROM 102 and a RAM 104, which are interconnected through data bus 106. The CGROM 103 stores dot pattern data for display being associated with corresponding code data, for each of a large number of characters.

The keyboard 3, the detection switches 6, a liquid crystal display controller (hereinafter referred to as LCDC) 109, drive circuits 107 and 108, and a USB interface 110 are connected to the I/O interface 105. The LCDC 109 is equipped with a video RAM (not shown) for outputting display data on the liquid crystal display unit 4. The drive circuits 107 and 108 drive the thermal head 11 and a tape feeding motor 37, respectively. The USB interface 110 is used for connecting to the PC 900.

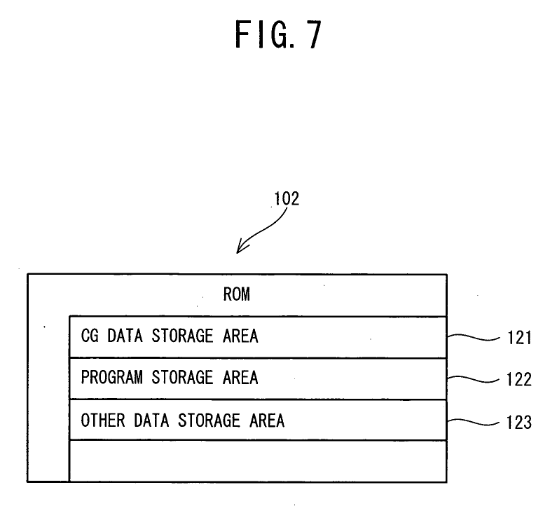

As shown in FIG. 7, the ROM 102 includes a CG data storage area 121, a program storage area 122 and other data storage area 123. The CG data storage area 121 stores print dot pattern data being associated with corresponding code data for each of characters such as alphabetic characters and symbols. The print dot pattern data is classified by font, such as Gothic style and Mincho style, and the stored print dot pattern data for each font includes data for six print character sizes (16, 24, 32, 48, 64, 96 dots). The CG data storage area 121 also stores graphic pattern data for printing graphic images.

The program storage area 122 stores various kinds of programs for controlling the tape printer 1, such as a display drive control program, a print drive control program, an operation control program. The display drive control program controls the LCDC 109 in response to the code data of characters inputted through the keyboard 3. The print drive control program reads data stored in a print buffer 142 (see FIG. 8) and controls drive of the thermal head 11 and the tape feeding motor 37. The CPU 101 executes various kinds of arithmetic operations based on these and other programs stored in the ROM 102.

As shown in FIG. 8, the RAM 104 includes a text buffer 141, the print buffer 142, a special font registration permission flag area 143, a special template registration permission flag area 144, special print permission flag area 145, special program registration permission flag area 146 and other data storage area 147. The text buffer 141 stores document data inputted through the keyboard 3. The print buffer 142 stores print dot patterns of characters, number of pulses to be applied, which corresponds to formation energy for each dot, as the dot pattern data. The printing of the thermal head 11 can be carried out according to the dot pattern data stored in the print buffer 142. When No. 7 detection switch 6 is ON, flag-on is stored in the special font registration permission flag area 143. When No. 8 detecting switch 6 is ON, flag-on is stored in the special template registration permission flag area 144. When No. 9 detection switch 6 is ON, flag-on is stored in the special print permission flag area 145. When No. 10 detection switch 6 is on, flag-on is stored in the special program registration permission flag area 146.

In the tape printer 1 having the above-described structure, when characters are inputted through keys 31 of the keyboard 3, corresponding text is stored successively in the text buffer 141 of the RAM 104 and a dot pattern corresponding to the input characters are displayed on the liquid crystal display unit 4 according to the dot pattern generation control program and the display drive control program. The thermal head 11 is driven by the drive circuit 107 so as to print dot pattern data stored in the print buffer 142, and synchronously with this, the tape feeding motor 37 is driven by the drive circuit 108 so as to control tape feeding. In the thermal head 11, its heat generating elements are selectively heated corresponding to print dots of a line by the drive circuit 107 so as to print characters on the tape.

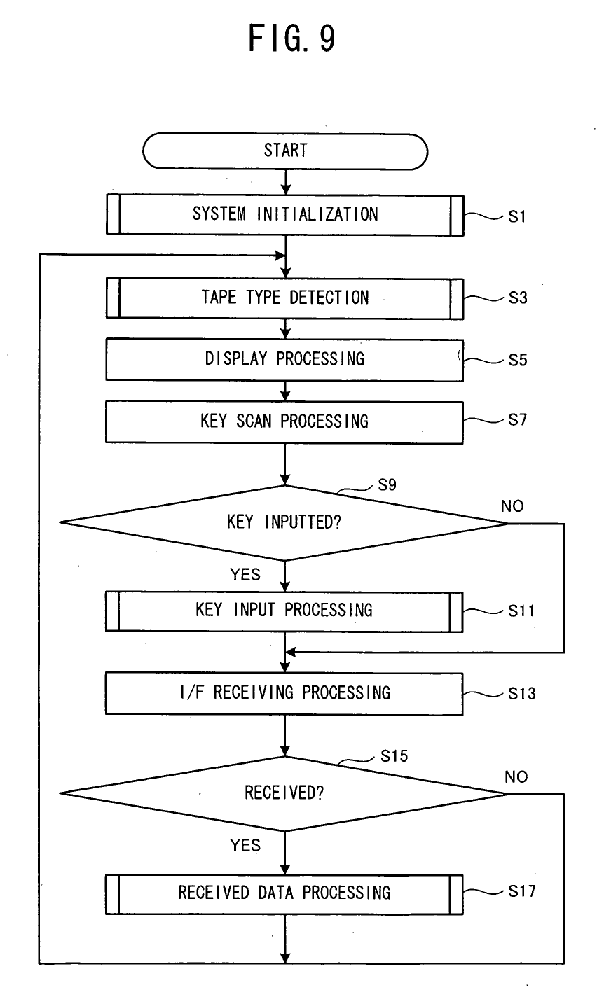

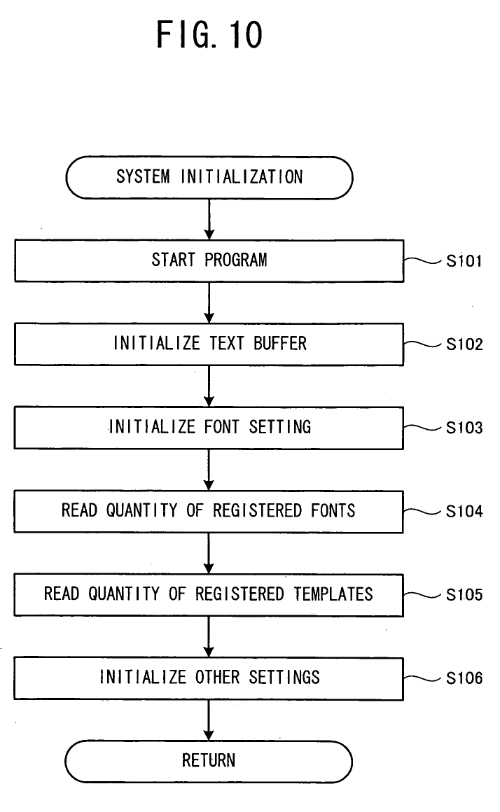

Next, an operation of the tape printer 1 having the above-described structure will be described with reference to FIGS. 9-28. When the tape printer 1 is turned on, it starts its main processing shown in FIG. 9. First, system initialization processing is executed (S1). The detail of the system initialization processing will be described in detail with reference to FIG. 10. First, various programs stored in the ROM 102 are loaded and started (S101). Next, the text buffer 141 in the RAM 104 is cleared and initialized (S102). Then, font settings are initialized and reset (S103). Next, the quantity of registered fonts is read (S104) and the quantity of registered templates is read (S105). Finally, other various initialization processings are executed (S106) and the procedure is returned to the main processing (FIG. 9).

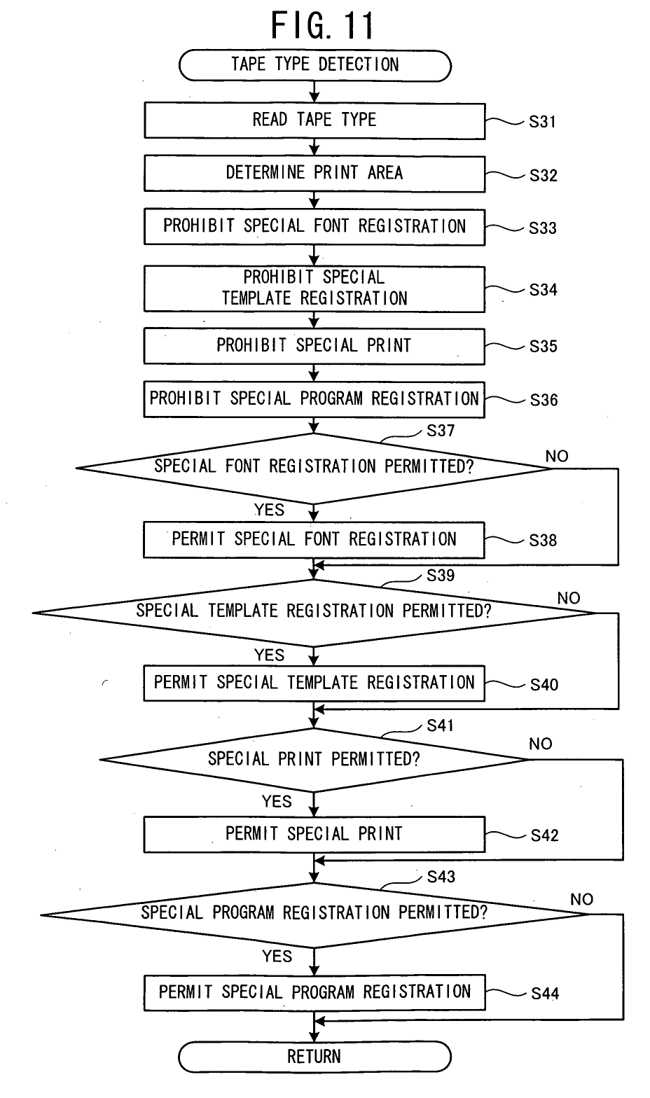

After the system initialization is completed, the type of a mounted tape is detected (S3). The tape detection processing will be described with reference to FIG. 11. First, the type of a currently loaded tape cassette 51 is detected by signals from the detection switches 6 (S31). Next, its print area is determined from the type of the detected tape (S32). Then, as initial setting, the registration permission flag of the special font is set to OFF (prohibition). Further, the registration permission flag of the special template is set to OFF (prohibition) (S34). Next, the special print permission flag is set to OFF (prohibition) (S35). Further, the registration permission flag of the special program is set to OFF (prohibition) (S36).

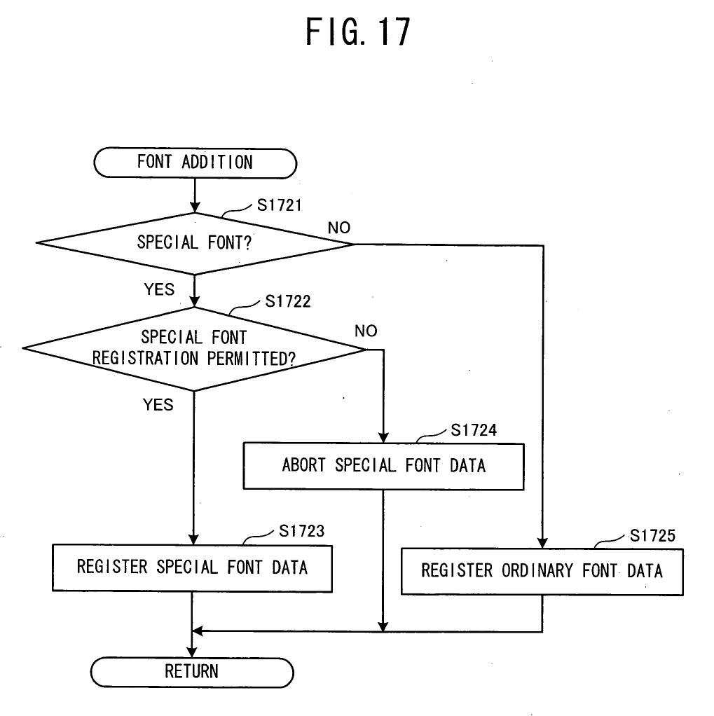

Next, it is determined whether the detected tape is a tape for which registration of the special font is permitted (S37). If it is the tape for which the registration of the special font is permitted (S37: YES), the special font registration permission flag is set to ON (permission) (S38). If it is not the tape for which the special font registration is permitted (S37: NO), the procedure proceeds to S39. Under such settings, if font data received from the PC 900 is special font data, it is registered in the tape printer 1 in which the flag is ON, but it is aborted and not registered in another tape printer 1 (to be described later with reference to FIG. 17).

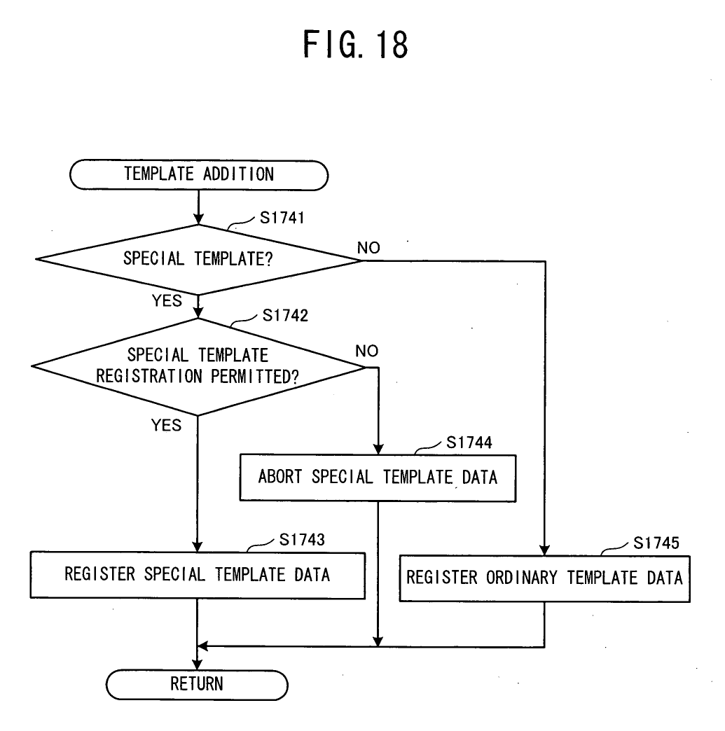

Next, it is determined whether the detected tape is a tape for which registration of the special template is permitted (S39). If it is the tape for which the special template registration is permitted (S39: YES), the special template registration permission flag is set to ON (permission) (S40). If it is not the tape for which the special template registration is permitted (S39: NO), the procedure proceeds to S41. Under such settings, if template data received from the PC 900 is special template data, it is registered in the tape printer 1 in which the flag is ON, but it is aborted and not registered by another tape printer 1 (described later with reference to FIG. 18).

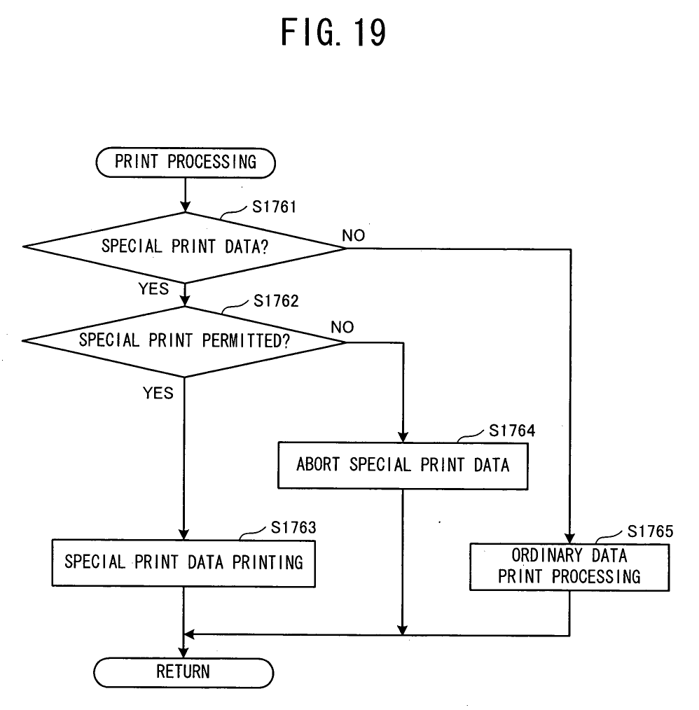

Next, it is determined whether the detected tape is a tape for which the special print is permitted (S41). If it is the tape for which the special print is permitted (S41: YES), the special print permission flag is set to ON (permission) (S42). If it is not the tape for which the special print is permitted (S41: NO), the procedure proceeds to S43. Under such settings, if print data received from the PC 900 is special data, it is printed by the tape printer 1 in which the flag is set to on, but it is aborted and not printed by another tape printer 1 (to be described later with reference to FIG. 19).

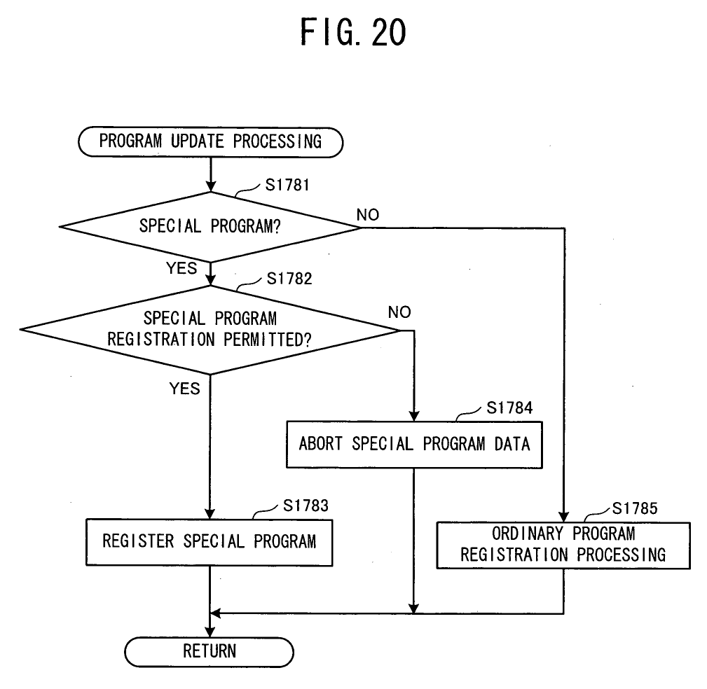

Next, it is determined whether the detected tape is a tape for which registration of the special program is permitted (S43). If it is the tape for which the registration of the special program is permitted (S43: YES), the special program registration permission flag is set to ON (permission) (S44). Then, the procedure is returned to the main processing. If it is not the tape for which the registration of the special program is permitted (S43: NO), the procedure proceeds to the main processing. Under such settings, if updating program data received from the PC 900 is special program data, it is registered in the tape printer 1 in which the flag is ON, but it is aborted and not registered in another tape printer 1 (to be described later with reference to FIG. 20).

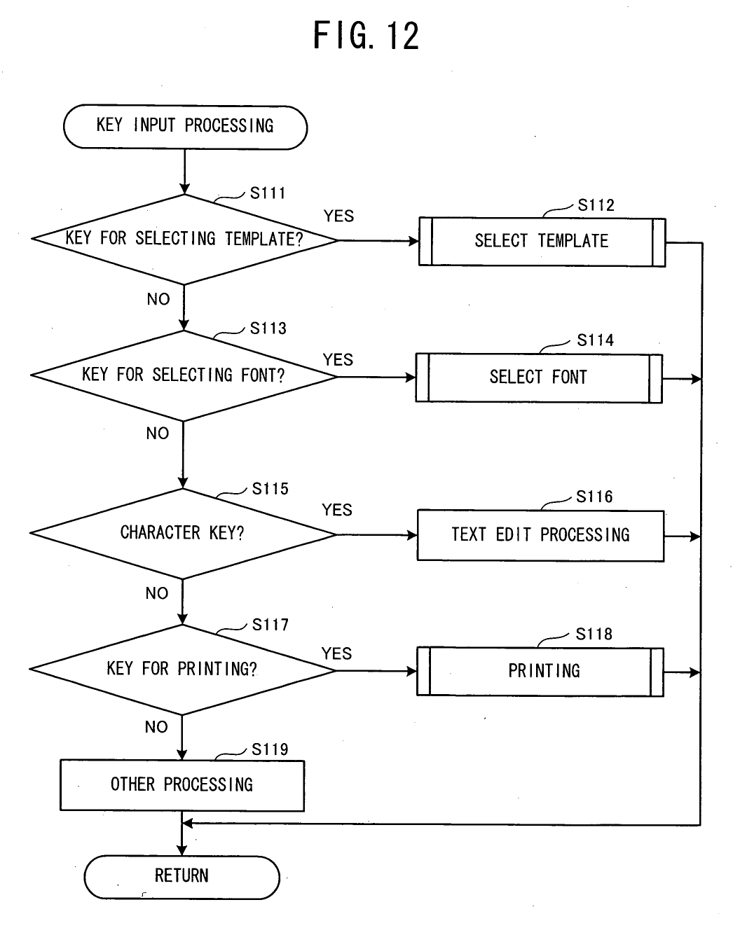

After the tape detection processing is completed, display processing to the liquid crystal display unit 4 is executed (S5). Next, key scan processing for checking whether input is made through the keyboard 3 is executed (S7). Then, it is determined whether a key is inputted (S9). If the key input is made (S9: YES), key input processing corresponding to the inputted key is executed (S11). The detail of the key input processing will be described later with reference to FIG. 12. If the key input is not made (S9: NO), the procedure proceeds to S13.

Next, data through the USB interface 110 is received, if any (S13). Then, it is determined whether any data is received (S15). If any data is received (S15: YES), received data processing corresponding to the received data is executed (S17) and the procedure is returned to S3. If no data is received (S15: NO), the procedure is returned to S3. The above-described main processing is executed repeatedly.

Next, the key input processing to be executed in S11 of the main processing will be described with reference to FIG. 12. First, it is determined whether the detected key input is a key for selecting a template (S111). If it is the key for selecting a template (S111: YES), template selection processing is executed (S112). Then, the procedure is returned to the main processing.

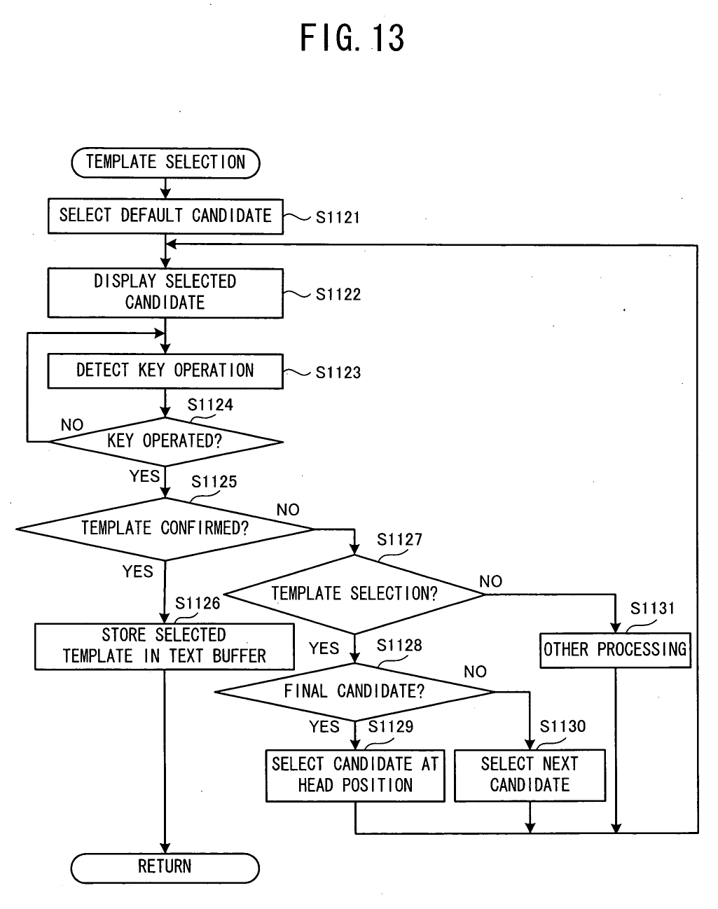

The template selection processing will be described with reference to FIG. 13. First, as a initial setting, default template candidate is selected (S1121). Next, a candidate selected by the inputted key is displayed (S1122). Next, key operation is detected, if any (S1123). If no key operation is made (S1124: NO), the procedure is returned to S1123, in which detection of the key operation is repeated.

If the key operation is made (S1124: YES), it is determined whether the detected key operation is an operation for confirming the selected template (S1125). If it is the operation for confirming the template (S1125: YES), the selected and confirmed template is stored in the text buffer 141 (S1126) and the procedure is returned to key input processing.

If it is not the operation for confirming the template (S1125: NO), next, it is determined whether the detected key operation is an operation for selecting a template (S1127). If it is the operation for selecting a template (S1127: YES), then it is determined whether the current selected candidate is a final one (S1128).

If it is the final candidate (S1128: YES), a template at the head is selected as a next candidate (S1129) and the procedure is returned to S1122, in which the selected candidate is displayed. If it is not the final candidate (S1128: NO), a next candidate template is selected (S1130) and the procedure is returned to S1122 in which the selected candidate is displayed. The above-described processing is repeated until the template confirming operation is made and after the template is confirmed, the template is stored in the text buffer 141 (S1126) and the procedure is returned to the key input processing.

If the key operation is not the operation for selecting a template (S1127: NO), other processing is executed (S1131) and the procedure is returned to S1122, in which the selected candidate is displayed. The above-described processing is repeated until the template confirming operation is made and after the template is confirmed, the template is stored in the text buffer 141 (S1126) and the procedure is returned to the key input processing.

Returning to FIG. 12, explanation of the key input processing will be continued. If the detected key input is not the key for selecting a template (S111: NO), it is determined whether it is a key for selecting a font (S113). If it is the key for selecting a font (S113: YES), the font selection processing is executed (S114). Then, the procedure is returned to the main processing.

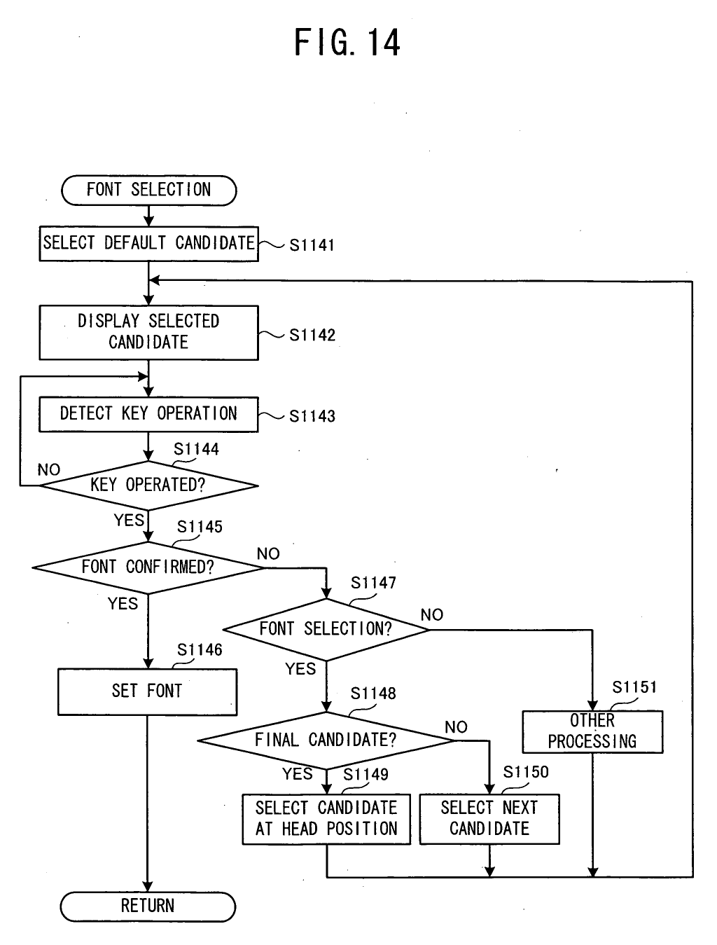

Here, the font selection processing will be described with reference to FIG. 14. First, as a initial setting, a default font candidate is selected (S1141). Next, a candidate selected by the inputted key is displayed (S1142). Next, key operation is detected, if any (S1143). If any key operation is not made (S1144: NO), the procedure is returned to S1143, in which detection for the key operation is repeated.

If the key operation is made (S1144: YES), it is determined whether the detected key operation is an operation for confirming the selected font (S1145). If it is the operation for confirming the selected font (S1145: YES), the selected font setting is confirmed (S1146) and the procedure is returned to the key input processing.

If it is not the operation for confirming the selected font (S1146: NO), next, it is determined whether the detected key operation is an operation for selecting a font (S1147). If it is the operation for selecting a font (S1147: YES), then it is determined whether the current selected candidate is a final one (S1148).

If it is the final candidate (S1148: YES), a candidate at the head is selected as a next candidate (S1149) and the procedure is returned to S1142, in which the selected candidate is displayed. If it is not the final candidate (S1148: NO), a next candidate font is selected (S1150) and the procedure is returned to S1142, in which the selected candidate is displayed. The above-described processing is repeated until the font confirming operation is made so as to confirm the font setting (S1146) and then the procedure is returned to the key input processing.

If the key operation is the not the operation for selecting a font (S1147: NO), other processing is executed (S1151) and the procedure is returned to S1142, in which the selected candidate is displayed. The above-described processing is repeated until the font confirming operation is made and after the font is confirmed (S1146), the procedure is returned to the key input processing.

Returning to FIG. 12, the description of the key input processing will be continued. If the detected key input is not the key for selecting a font (S113: NO), next, it is determined whether it is a character key (S115). If it is the character key (S115: YES), text edit processing is executed (S116). Then, the procedure is returned to the main processing.

If the detected key input is not the character key (S115: NO), next, it is determined whether it is a key for printing (S117). If it is the key for printing (S117: YES), the print processing is executed (S118). Then, the procedure is returned to the main processing. If the detected key input is not the key for printing, other processing is executed (S119) and the procedure is returned to the main processing.

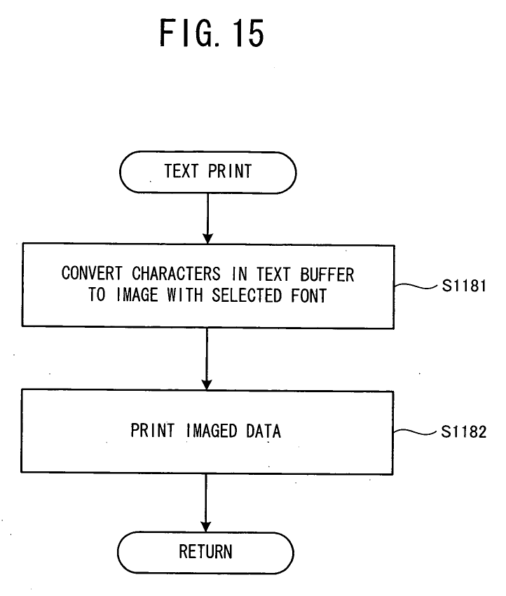

Here, the text print processing will be explained by referring to FIG. 15. First, characters stored in the text buffer 141 are converted to images with selected font (S1181). Then, the imaged data is printed (S1182) and the procedure is returned to the key input processing.

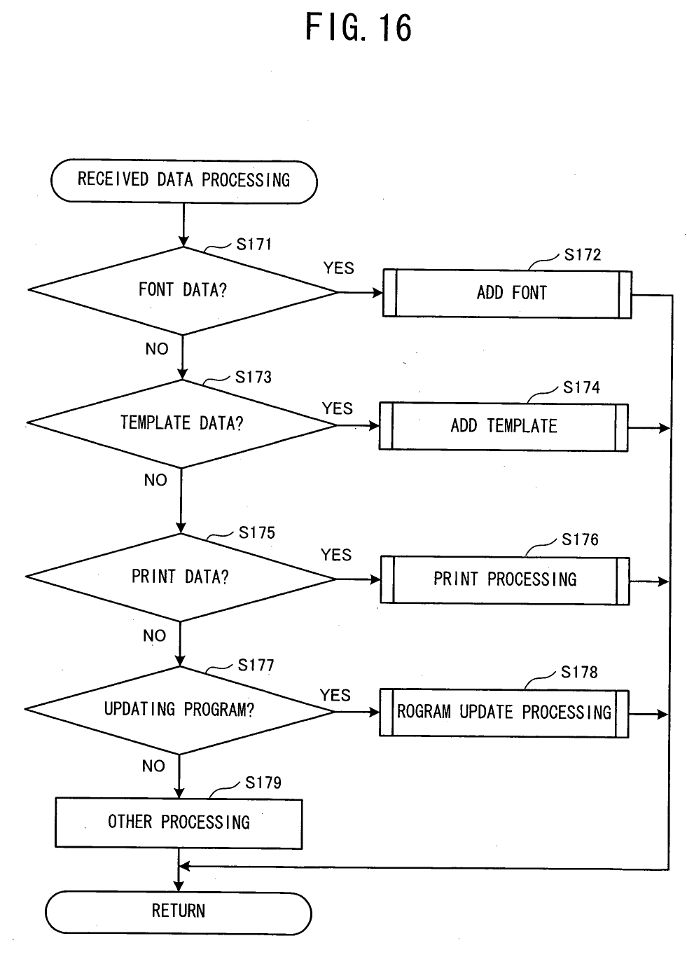

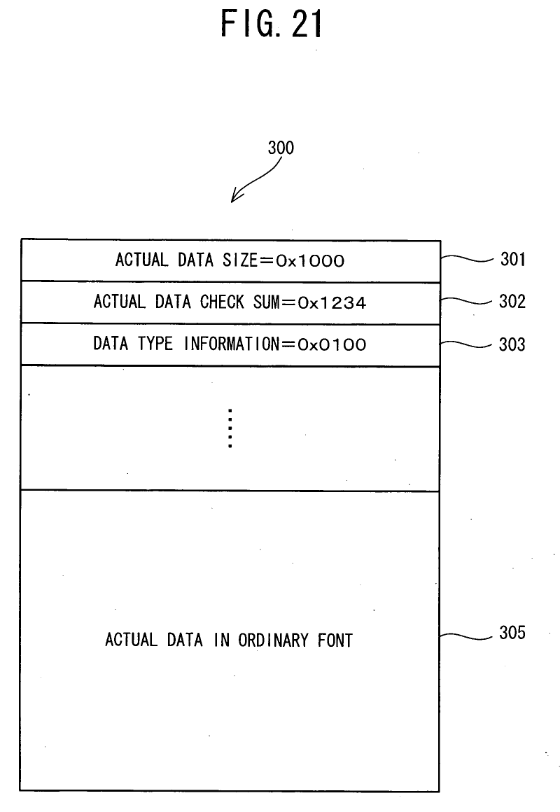

Next, the received data processing to be executed in S17 of the main processing will be described with reference to FIG. 16. The structure of data to be received in the received data processing will be described with reference to FIGS. 21 to 28. As shown in FIGS. 21-28, the received data include header information and actual data. The header information contains at least actual data size information 301, 311, 401, 411, 501, 511, 601, 611, check sum information 302, 312, 402, 412, 502, 512, 602, 612, and data type information 303, 313, 403, 413, 503, 513, 603, 613. Values described in the header information are of hexadecimal number (0x).

The size of the actual data indicates a byte count of the actual data following the header information. For example, the actual size 301 of ordinary font data indicated in FIG. 21 is 0x1000 byte. By reading this size information 301 preliminarily, data corresponding to the byte count (0x1000 bytes) described in the size information 301 can be read out without fault.

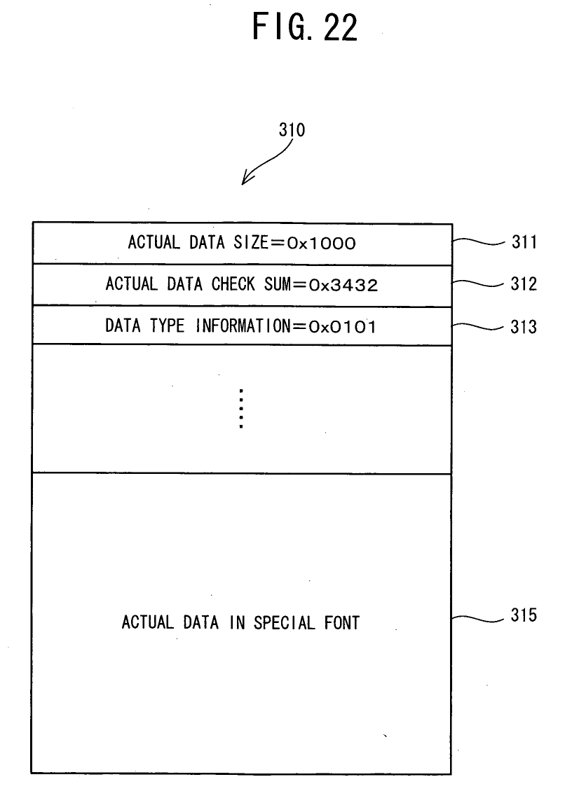

The check sum information of the actual data is to detect an error in sending data. In this embodiment, the value of lower 4 bytes of a sum obtained by summing up all the actual data before sending is described in the header information as the check sum information. For example, in the check sum information 312 shown in FIG. 22, the value of the check sum is 0x3432. Any error is detected by comparing the lower 4 bytes of the sum obtained by summing up all the received actual data with the check sum information.

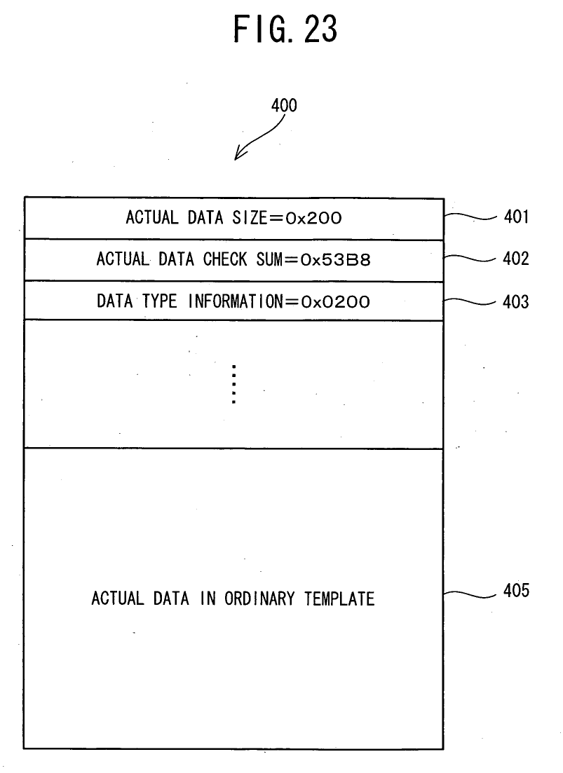

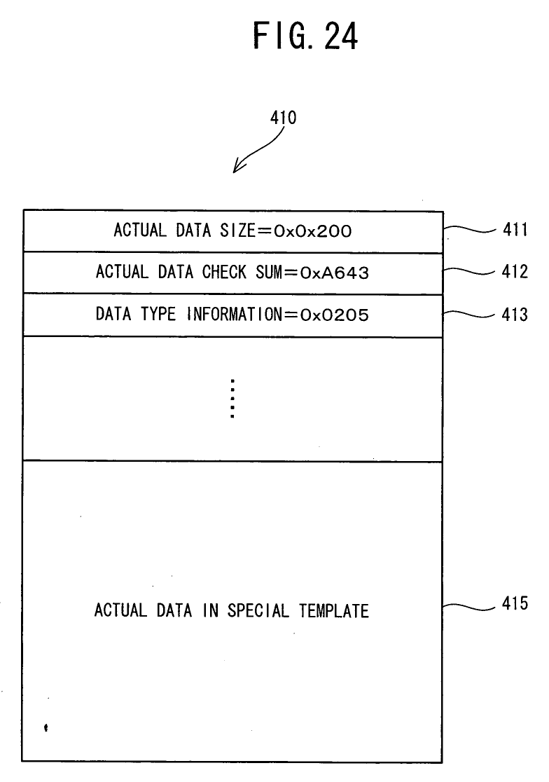

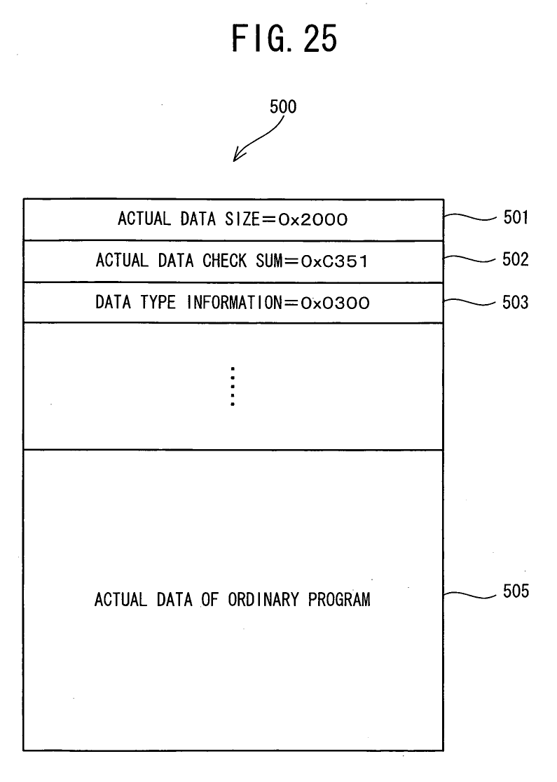

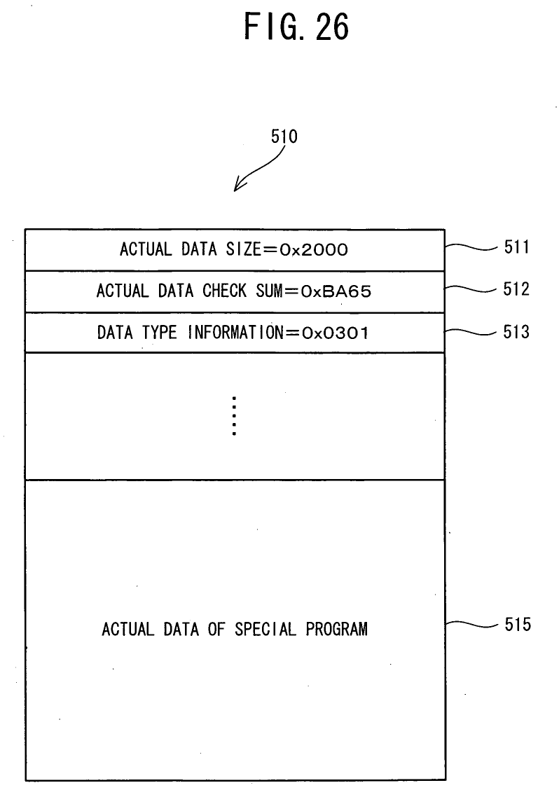

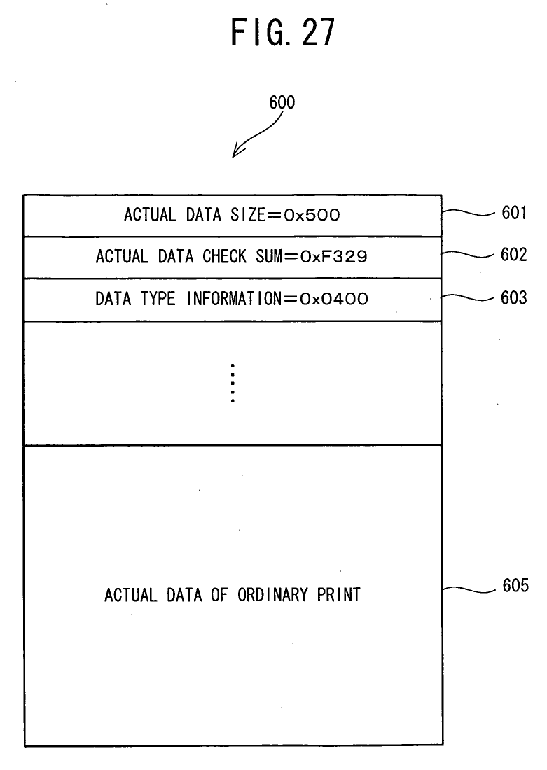

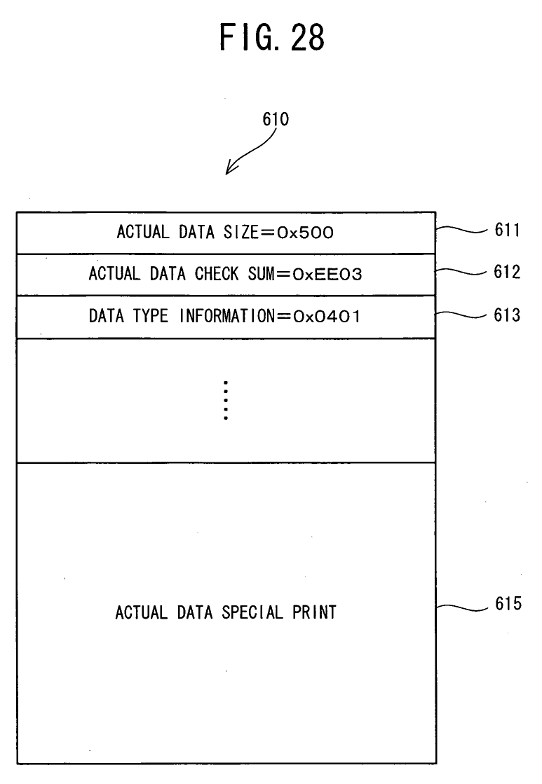

The data type information is a value which distinguishes whether the actual data following the header information is ordinary data or special data. If the lower two digits are “00”, the following actual data is ordinary data, and otherwise, the following actual data is special data. The value of the third digit indicates the type of the actual data. That is, if the third digit is “1”, it indicates font data, if it is “2”, template data, if it is “3”, program data, and if it is “4”, print data. For example, the data type information 303 shown in FIG. 21 is “0x0100”. The lower two digits are “00” and the third digit is “1” thereby indicating that the data is ordinary font data. The data type information 303 shown in FIG. 22 is “0x0101”. The lower two digits are not “00” and the third digit is “1”, thereby indicating that the data is special font data. The data type information 403 shown in FIG. 23 is “0x0200”. The lower two digits are “00” and the third digit is “2” thereby indicating that the data is ordinary template data. The data type information 413 shown in FIG. 24 is “0x0205”. The lower two digits are not “00” and the third digit is “2” thereby indicating that the data is special template data. The data type information 503 shown in FIG. 25 is “0x0300”. The lower two digits are “00” and the third digit is “3” thereby indicating that the data is ordinary program data. The data type information 513 shown in FIG. 26 is “0x0301”. The lower two digits are not “00” and the third digit is “3” thereby indicating that the data is special program data. The data type information 603 shown in FIG. 27 is “0x0400”. The lower two digits are “00” and the third digit is “4” thereby indicating that the data is ordinary print data. Further, the type information 413 shown in FIG. 28 is “0x0401”. The lower two digits are not “00” and the third digit is “4” thereby indicating that the data is special print data.

In the received data processing shown in FIG. 16, it is determined whether the received data is font data (S171). It is determined by referring to the third digit of the data type information of the received data. If the value is “1”, it is font data. If it is font data (S171: YES), the font addition processing is executed (S172) and the procedure is returned to the main processing.

Here, the font addition processing will be described with reference to FIG. 17, FIG. 21 and FIG. 22. After the font addition processing is started, it is determined whether the received font data is special font data (S1721). It can be determined depending on the lower two digits of the data type information 303 or 313. If the two digits are not “00”, it is special font data.

If the received data is special font data (S1721: YES) next, it is determined whether registration of the special font is permitted (S1722). It can be done depending on the special font registration permission flag stored in the special font registration permission flag area 143. If the flag is ON, it is permitted. If the registration of the special font is permitted (S1723: YES), the received special font data is registered (S1723) and the procedure is returned to the received data processing. If the registration of the special font is not permitted (S1722: NO), the received special font data is aborted (S1724) and the procedure is returned to the received data processing. On the tape printer 1 in which the special font data is required to be registered, the tape cassette 51 with no identification hole 661 facing No. 7 detection switch 6 (No. 7 detection switch 6 is ON) should be loaded. The PC 900 does not need to select a tape printer 1 to send the special font data so as to register the special font on such tape printer 1, but it can send the special font data to all the tape printers 1.

If the received data is not the special font but ordinary font data (S1721: NO), the received ordinary font data is registered (S1725) and the procedure is returned to the received data processing.

Returning to FIG. 16, the description of the received data processing will be continued. If the received data is not font data (S171: NO), next, it is determined whether the received data is template data (S173). It is determined by referring to the third digit of the data type information of the received data. If the value is “2”, it is template data. If it is template data (S173: YES), the template addition processing is executed (S174) and the procedure is returned to the main processing.

Here, the template addition processing will be described with reference to FIG. 18, FIG. 23 and FIG. 24. After the template addition processing is started, it is determined whether the received template data is special template (S1741). It can be determined depending on the lower two digits of the data type information 403 or 413. If the two digits are not “00”, it is special template data. If the received data is special template data (S1741: YES), next, it is determined whether registration of the special template is permitted (S1742). It can be determined depending on the special template registration permission flag stored in the special template registration permission flag area 144. If the flag is ON, it is permitted. If the registration of the special template is permitted (S1743: YES), the received special template data is registered (S1743) and the procedure is returned to the received data processing. If the registration of the special template is not permitted (S1742: NO), the received special template data is aborted (S1744) and the procedure is returned to the received data processing. On the tape printer 1 in which the special template data is required to be registered, the tape cassette 51 with no identification hole 661 facing No. 8 detection switch 6 (No. 8 detection switch 6 is ON) should be loaded. The special template data can be sent to all the tape printers 1, that is, the PC 900 does not need to select a tape printer 1 to send the special template data so as to register the special template on such tape printer 1.

If the received data is not special template but ordinary template (S1741: NO), the received ordinary template data is registered (S1745) and the procedure is returned to the received data processing.

Returning to FIG. 16, the description of the received data processing will be continued. If the received data is not template data (S173: NO), it is determined whether the received data is print data (S175). As stated above, it is determined by referring to the third digit of the data type information of the received data. If the value is “4”, it is print data. If the received data is print data (S175: YES), the print processing is executed (S176) and the procedure is returned to the main processing.

Here, the print processing will be described with reference to FIG. 19, FIG. 27 and FIG. 28. After the print processing is started, it is determined whether the received data is special print data (S1761). As stated above, it can be determined depending on the lower two digits of the data type information 603 or 613. If the two digits are not “00”, it is special print data. If the received data is special print data (S1761: YES), next, it is determined whether special print is permitted (S1762). It can be determined depending on the special print permission flag stored in the special print permission flag area 145. If the flag is ON, it is permitted. If the special print is permitted (S1763: YES), printing of the received special print data is executed (S1763) and the procedure is returned to the received data processing. If the special print is not permitted (S1762: NO), the received special print data is aborted (S1764) and the procedure is returned to the received data processing. On the tape printer 1 in which special data is required to be printed, the tape cassette 51 with no identification hole 661 facing No. 9 detection switch 6 (No. 9 detection switch is ON) should be loaded. The PC 900 does not need to select a tape printer 1 to send the special data so as to print the special data on such tape printer 1, but it can send the special data to all the tape printers 1.

If the received data is not special print data but ordinary print data (S1761: NO), printing of the received ordinary print data is executed (S1765) and the procedure is returned to the received data processing.

Returning to FIG. 16, the description of the received data processing will be continued. If the received data is not print data (S175: NO), next, it is determined whether the received data is program updating data (S177). As stated above, it is determined by referring to the third digit of the data type information of the received data. If the value is “3”, it is program updating data. If the received data is program updating data (S177: YES), the program updating processing is executed (S178) and the procedure is returned to the main processing.

Here, the program updating processing will be described with reference to FIG. 20, FIG. 25 and FIG. 26. After the program updating processing is started, it is determined whether the received program data is special program (S1781). It can be determined depending on the lower two digits of the data type information 503 or, 513. If the two digits are not “00”, it is special program. If the received data is special program (S1781: YES), next, it is determined whether registration of the special program is permitted (S1782). It can be determined depending on the special program registration permission flag stored in the special program registration permission flag area 146. If the flag is ON, it is permitted. If the special program registration is permitted (S1782: YES), the received special program data is registered (S1783) and the procedure is returned to received data processing. If the registration of the special program is not permitted (S1782: NO), the received special program data is aborted (S1784) and the procedure is returned to the received data processing. On the tape printer 1 in which the special program data is required to be registered, the tape cassette 51 with no identification hole 661 facing No. 10 detection switch 6 (No. 10 detection switch 6 is ON) should be loaded. The PC 900 does not need to select a tape printer 1 to send the special program data so as to register the special program on such tape printer 1, but it can send the special program data to all the tape printers 1.

If the received data is not the special program but ordinary program (S1781: NO), the received ordinary program is registered (S1785) and the procedure is returned to the received data processing.

As described above, in the tape printer 1 of this embodiment, registration of the special font, registration of the special template, print of the special data and registration of the special program are treated as special operation. Then, whether any one of these is permitted or prohibited can be detected with the identification holes 661 provided in the tape cassette 51 and the detection switches 6. Thus, on the tape printer 1 in which any corresponding special operation is required to be executed, the tape cassette 51 which permits the special operation is loaded. The PC 900 can send data for executing the special operation (special font data, special template data, special print data, and special program data) to all the connected tape printers 1. Because no data sending needs to be carried out by selecting the tape printer 1, operations on the PC 900 can be executed effectively. An aimed special operation can be executed only by attaching/detaching the tape cassette 51 on the tape printer 1.

The configuration of the tape printer 1 shown in the above-described exemplary embodiment is only an example and may be modified in various ways.

What is claimed is:

1. A tape printer for printing a tape stored in a detachable tape cassette comprising:
a detection device that detects a type of a loaded tape cassette;
a receiving device that receives data from an external device;
a permission determination device that determines whether or not the type of the cassette detected by the detection device permits a predetermined action except ordinary printing the predetermined action being instructed in data received by the receiving device; and
an operation control device that enables the predetermined action if it is determined to be permitted by the permission determination device.

2. The tape printer according to claim 1, further comprising:
a font storage device that stores print font, wherein
the predetermined action is registration of a predetermined kind of font to the font storage device.

3. The tape printer according to claim 1, further comprising: a template storage device that stores templates that are specified formats, wherein
the predetermined action is registration of a predetermined template to the template storage device.

4. The tape printer according to claim 1, wherein
the predetermined action is printing predetermined print data.

5. The tape printer according to claim 1, wherein
the predetermined action is registration of a predetermined program.

6. A tape print program recorded on a computer-readable recording medium, the program comprising instructions that cause a controller of a tape printer for printing a tape stored in a detachable tape cassette to perform:
a detection step of detecting the type of the tape cassette loaded in the tape printer;
a receiving step of receiving data from an external device;
a permission determination step of determining whether or not the type of the cassette detected in the detection step permits a predetermined action except ordinary printing the predetermined action being instructed in data received in the receiving step; and
an operation control step of enabling the predetermined action if it is determined to be permitted by the permission determination step.

7. The tape print program according to claim 6, wherein
the predetermined action is registration of predetermined kind of font to a font storage device that stores print fonts.

8. The tape print program according to claim 6, wherein
the predetermined action is registration of a predetermined template to a template storage device that stores templates that are specified formats.

9. The tape print program according to claim 6, wherein
the predetermined action is printing predetermined print data.

10. The tape print program according to claim 6, wherein
the predetermined action is registration of a predetermined program.

11. A tape cassette for use in a tape printer comprising:
an identification section that makes the tape printer detect whether or not a predetermined action except ordinary printing is permitted to the tape printer.
